(19) United States
(12) Patent Application Publication
(10) Pub. No.: US 2019/0361296 A1
(43) Pub. Date: Nov. 28, 2019

(54) BACKLIGHT MODULE AND DISPLAY DEVICE

(71) Applicant: Wuhan China Star Optoelectronics Technology, Co., Ltd., Wuhan (CN)

(72) Inventor: Guowei Zha, Shenzhen (CN)

(21) Appl. No.: 16/167,595

(22) Filed: Oct. 23, 2018

Related U.S. Application Data
(63) Continuation of application No. PCT/CN2018/107450, filed on Sep. 26, 2018.

(30) Foreign Application Priority Data
May 28, 2018 (CN) 201810523970.8

(51) Int. Cl. G02F 1/1335; G02B 27/09

(52) U.S. Cl. CPC G02F 1/133605; G02F 1/133606; G02F 1/133611; G02B 27/0977

(57) ABSTRACT

The present disclosure provides a backlight module and a display device. The backlight module includes a substrate, a plurality of lamp sources, a fluorescent film, a pointing film and a brightness enhancement film disposed on the substrate. The fluorescent film is disposed along a light output direction of the plurality of lamp sources. The pointing film and the brightness enhancement film are disposed along a light output direction of the fluorescent film. The pointing film is disposed between the fluorescent film and the brightness enhancement film and includes a transparent body and a plurality of tapered protrusions arrayed on the surface of one side of the transparent body at intervals, and a central angle of each of the plurality of tapered protrusions is an acute angle.

### CROSS-REFERENCE TO RELATED APPLICATIONS

The present application is a continuation-application conversion of International (PCT) Patent Application No. PCT/CN2018/107450 filed on Sep. 26, 2018, which claims foreign priority of Chinese Patent Application No. 201810523970.8, filed on May 28, 2018 in the State Intellectual Property Office of China, the contents of all of which are hereby incorporated by reference.

### TECHNICAL FIELD

Embodiments of the present disclosure generally relate to display field, in particular to a backlight module and a display device.

### BACKGROUND

At present, drive bonding regions are generally reserved on the lower borders of display devices such as liquid crystal displays (LCDs). As shown in FIG. 1, a wire fanout region 12, an IC bonding (Integrated-Circuit bonding) region 13 and a FPC (Flexible Printed Circuit) bonding region 14 are disposed in a lower border 11 of a display device 10. Wires such as data wires are fanned out via the wire fanout region 12, ICs such as a source driver are arrayed in the IC bonding region 13, and FPCs are arrayed in the FPC bonding region 14. Due to the presence of these three regions, it is difficult to decrease the width of the lower border 11. In order to increase the screen-to-body-ratio, the COF (Circuit On Film) design has been commonly adopted by existing display devices. As shown in FIG. 2, only a FPC bonding region 22 is disposed in a lower border 21 of a display device 20, and ICs 23 are directly disposed in the FPC bonding region 22.

A backlight module of the display device 20 may be of an edge type or a direct type. As shown in FIG. 3, in the structural design of an edge-type backlight module 30, a lamp source 31 is located on one side of a light guide plate 32, and only if a light mixing region 33 used for mixing lights is reserved between the lamp source 31 and an effective working area of the light guide plate 32 (namely an area overlapping with an effective display area 24 of the display device 20), uniform light output can be ensured, and hotspots can be prevented from being generated near the lamp source 31. To make full use of the space, the lamp source 31 is disposed in the lower border 21 of the display device 20, as shown in FIG. 2 and FIG. 3. However, due to the fact that the lamp source 31 has a certain thickness and that the size, concerning the light output uniformity of the display device 20, of the light mixing region 32 may hardly be decreased, the lower border 21 still has a large size. Generally speaking, the limit size of the lower border 21 is about 2-3 mm, and there is still a large difference between the size of the lower border 21 and the size, which is smaller than 1 mm, of left and right borders.

In the case where the display device 20 adopts a direct-type backlight module, a lamp source is located behind an effective display area 24 of the display device 20 instead of being located on one side of the effective display area 24 of the display device 20, so that the size of the lower border 21 can be decreased. However, in the direct-type backlight module, lights output by a diffusion film are uniformly-distributed Lambertian lights typically having a divergence angle of 100°-160°, the divergence angle of only part of the lights accords with the permissible emergence angle of a brightness enhancement film (BEF), the rest part of lights will be reflected by the BEF, and consequentially, the one-shot light output efficiency of the BEF is low, and the front display brightness of the display device 20 is low.

### SUMMARY

In view of this, embodiments of the present disclosure provides a backlight module and a display device, which may improve the one-shot light output efficiency of a brightness enhancement film, thus, enhancing the front display brightness of the display device.

In one embodiment of the disclosure, the backlight module comprises a substrate, and a plurality of lamp sources, a fluorescent film, a pointing film and a brightness enhancement film disposed on the substrate, the fluorescent film disposed along a light output direction of the plurality of lamp sources and comprising a transparent adhesive, and a fluorescent medium and scattering particles mixed in the transparent adhesive, and the scattering particles having a reflectivity smaller than a reflectivity of the transparent adhesive; the pointing film and the brightness enhancement film disposed along a light output direction of the fluorescent film, and the pointing film located between the fluorescent film and the brightness enhancement film; wherein the pointing film is of an integrally-molded structure and comprises a transparent body and a plurality of tapered protrusions arrayed on a surface of one side of the transparent body at intervals; and a central angle of each of the plurality of tapered protrusions is an acute angle and is 10°-60°.

In another embodiment of the disclosure, the backlight module comprises a substrate, and a plurality of lamp sources, a fluorescent film, a pointing film and a brightness enhancement film disposed on the substrate; the fluorescent film disposed along a light output direction of the plurality of lamp sources, and the pointing film and the brightness enhancement film disposed along a light output direction of the fluorescent film; the pointing film located between the fluorescent film and the brightness enhancement film and comprising a transparent body and a plurality of tapered protrusions arrayed on a surface of one side of the transparent body at intervals; and a central angle of each of the plurality of tapered protrusions is an acute angle.

In one embodiment of the disclosure, the display device comprises a backlight module, which comprises a substrate, and a plurality of lamp sources, a fluorescent film, a pointing film and a brightness enhancement film disposed on the substrate, the fluorescent film disposed along a light output direction of the plurality of lamp sources, and the pointing film and the brightness enhancement film disposed along a light output direction of the fluorescent film; the pointing film located between the fluorescent film and the brightness enhancement film and comprising a transparent body and a plurality of tapered protrusions arrayed on a surface of one side of the transparent body; and a central angle of each of the plurality of tapered protrusions is an acute angle.

The embodiments of the disclosure have the following effects. The pointing film is additionally disposed between the fluorescent film and the brightness enhancement film of the direct-type backlight module, the central angle of the plurality of tapered protrusions of the pointing film is an acute angle, Lambertian lights output by a diffusion film are distributed along a direction of the central angles of the plurality of tapered protrusions after entering the pointing film, so that uniformly-distributed lights are transformed to be directionally distributed and may have an angle according with an emergence angle required by the brightness enhancement film after being transmitted to the brightness enhancement film, and thus, the one-shot light output efficiency of the brightness enhancement film may be improved, the front light output brightness of the backlight module may be enhanced, and accordingly, the front display brightness of the display device may be improved.

### BRIEF DESCRIPTION OF THE DRAWINGS

FIG. 1 is a top schematic view of a display device in one embodiment of the related art.

FIG. 2 is a top schematic view of a display device in another embodiment of the related art.

FIG. 3 is a cross-sectional schematic view of an edge-type backlight module in one embodiment of the related art.

FIG. 4 is a cross-sectional schematic view of a backlight module in one embodiment of the disclosure.

FIG. 5 is a cross-sectional schematic view of a pointing film of the backlight module in FIG. 4.

FIG. 6 is a cross-sectional schematic view of a backlight module in another embodiment of the disclosure.

FIG. 7 is a cross-sectional schematic view of a display device in one embodiment of the disclosure.

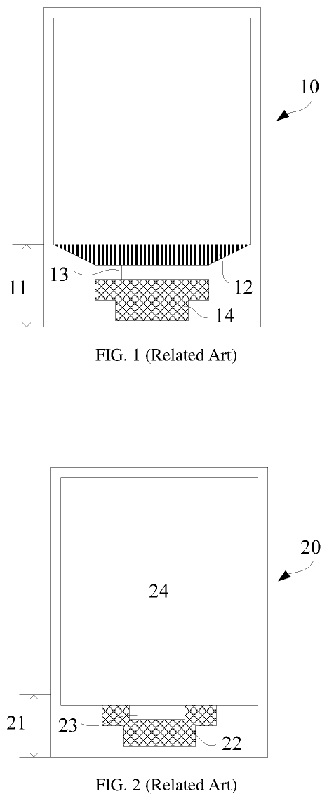

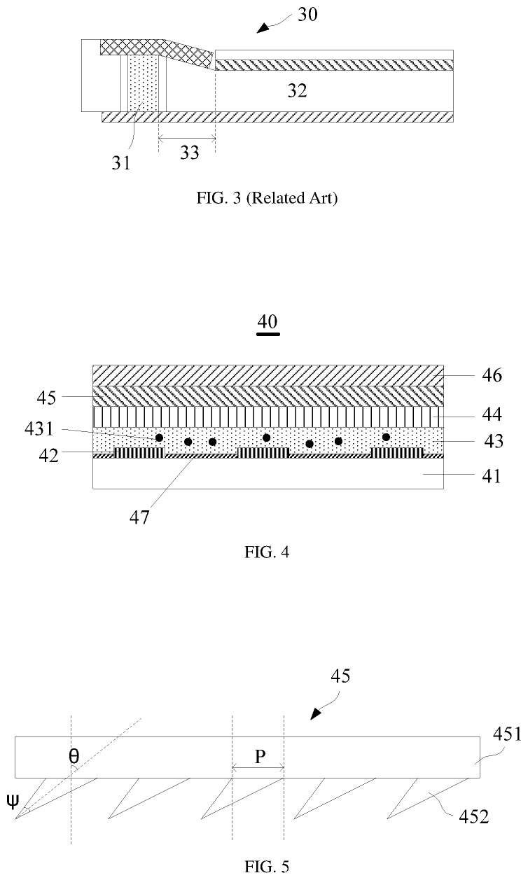

### DETAILED DESCRIPTION

The principal objective of the disclosure is as follows: a pointing film may be additionally disposed between a fluorescent film and a brightness enhancement film of a direct-type backlight module; a central angle of a plurality of tapered protrusions of the pointing film may be an acute angle, which means that the plurality of tapered protrusions may incline in a preset direction; after entering the pointing film, Lambertian lights output by a diffusion film may be distributed along a direction of the central angles of the plurality of tapered protrusions, so that the uniformly-distributed lights may be transformed to be directionally distributed and may have an angle according with an emergence angle required by the brightness enhancement film when transmitted to the brightness enhancement film. In this way, the one-shot light output efficiency of the brightness enhancement film may be improved, the front light output brightness of the backlight module may be enhanced, and accordingly, the front display brightness of the display device may be enhanced.

A clear and complete description of the technical solution of embodiments of the disclosure is given as follows in combination with the accompanying drawings. Under the non-conflicting condition, the following embodiments and technical characteristics of these embodiments can be mutually combined. In addition, directional terms such as “upper” and “lower” in the whole text are intended to better illustrate these embodiments rather than to limit the protection scope of the disclosure.

FIG. 4 is a cross-sectional schematic view of a backlight module in one embodiment of the disclosure. Please referring to FIG. 4, the backlight module 40 may include a substrate 41 and layers of structures such as a plurality of lamp sources 42, a fluorescent film 43, a diffusion film 44, a pointing film 45 and a brightness enhancement film 46 disposed on the substrate 41.

The substrate 41 may be regarded as a drive substrate of the backlight module 40. The aforesaid structural elements may be carried by the substrate 41, and drive circuits for driving the plurality of lamp source 42 to emit light, such as FPCs (or PCB short for Printed Circuit Board), ICs and relevant wires may also be arrayed on the substrate 41.

The plurality of lamp sources 42 may be disposed on the substrate 41 in an array manner and may be independently connected with the drive circuits to emit lights in a preset color, such as blue lights. Each of the plurality of lamp sources 42 may be a mini-LED and may have a size of 100-1000 μm, the distance between every two adjacent lamp sources 42 may be 100-2000 μm, and thus, a micro light-emitting array may be formed. The plurality of lamp sources 42 may be located on a same layer such as a flat layer. Particularly, after the arrangement of the plurality of lamp sources 42, the flat layer may be smeared between the adjacent lamp sources 42, and a upper surface of the flat layer may be a flat surface so as to easily bond with the fluorescent film 43. Of course, the flat layer may also be omitted in the embodiments of the disclosure, and the plurality of lamp sources 42 may be directly covered by the fluorescent film 43. Wherein, the fluorescent film 43 may be prepared through a hot-pressing method. As the materials used for preparing the fluorescent film 43 are in a molten state at a high temperature (<300° C.), the finally-prepared fluorescent film 43 may in close contact with the plurality of lamp sources 42 and the substrate 41. Correspondingly, an encapsulation layer of each of the plurality of lamp sources 42 and the substrate 41 should also be made from high-temperature materials.

The fluorescent film 43 may be disposed along a light output direction of the plurality of lamp sources 42. Wherein, the fluorescent film 43 may be prepared from a fluorescent medium (also called photoluminescent particle), scattering particles 431 and a transparent adhesive (such as transparent silicone) through mixing, and by controlling the ratio of the fluorescent medium to the scattering particles 431, the wavelength of lights output by the fluorescent film 43 and the light mixing uniformity may be fine adjusted. When excited by short-wavelength lights, the fluorescent medium may emit long-wavelength lights. For instance, if lights emitted by the plurality of lamp sources 42 are regarded as first original-color lights, the fluorescent medium may emit second original-color lights and third original-color lights when excited by the first original-color lights, and the wavelength of the second original-color lights and the wavelength of the third original-color lights may be both greater than the wavelength of the first original-color lights. The scattering particles 431 may be transparent and may be used for scattering lights and have a refractivity smaller than a refractivity of the transparent adhesive for preparing the fluorescent film 43, so that after being output by the fluorescent film 43, lights may have a large angle.

The diffusion film 44 may be disposed along a light output direction of the fluorescent film 43 and may be used for converting lights output by the fluorescent film 43 into uniformly-distributed lights, namely Lambertian lights.

The pointing film 45 and the brightness enhancement film 46 may be sequentially disposed along a light output direction of the diffusion film 44. As shown in FIG. 5, the pointing film 45 may include a transparent body 451 and a plurality of tapered protrusions 452, the plurality of tapered protrusions 452 may arrayed on a surface of one side of the transparent body 451 at intervals and having the same width P such as 1-50 μm. In addition, the distances between every two adjacent tapered protrusions 452 may also be the same. The plurality of tapered protrusions 452 may be disposed towards the fluorescent film 44 and may also be disposed towards the brightness enhancement film 46. A central angle θ of each of the plurality of tapered protrusions 452 may be an acute angle, for instance 10˜60°. The central angle θ refers to the included angle between the bisector of a vertex angle Ψ of each of the plurality of tapered protrusions 452 and the gravity direction. The vertex angle Ψ of each of the plurality of tapered protrusions 452 may also be an acute angle which may be at least greater than 30° and smaller than 90°.

In an actual application scene, the pointing film 45 may be of an integrally-molded structure. For instance, the pointing film 45 may be prepared from at least one selected from polymethyl methacrylate (PMMA), polycarbonate (PC), polystyrene (PS) and styrene-methyl methacrylate copolymer (MS) through one-shot injection molding in the embodiments of the disclosure. Of course, the transparent body 451 and the plurality of tapered protrusions 452 may also be formed through multiple procedures, but the transparent body 451 and the plurality of tapered protrusions 452 must be made from the same material and have the same refractivity.

The brightness enhancement film 46 may be a common prismatic lens, only allows lights at a predetermined inclination angle to pass through, and may concentrate lights towards the center so as to improve the front display brightness.

In the working process of the backlight module 40, Lambertian lights output by the diffusion film 44 may be distributed along a direction of the central angles θ of the plurality of tapered protrusions 452 after entering the pointing film 45, so that the uniformly-distributed lights may be transformed to be directionally distributed, and accordingly, the lights may have an angle according with the emergence angle required by the brightness enhancement film 46 when transmitted to the brightness enhancement film 46. In this way, the one-shot light output efficiency of the brightness enhancement film 46 may be improved, the front light output brightness of the backlight module 40 may be enhanced, and accordingly, the front display brightness of the display device with the backlight module 40 may be enhanced in the embodiments of the disclosure.

Referring to FIG. 4, the backlight module 40 may further include a reflector 47. The reflector 47 may be disposed along a light output direction of the substrate 41 and capable of reflecting lights. The reflector 47 defines a plurality of open areas instead of being a whole face structure. Perpendicular to a light output direction of the backlight module 40, the plurality of open areas may be completely matched with the plurality of lamp sources 42 in shape and size. Each of the plurality of lamp sources 42 may be disposed in each of the plurality of open areas of the reflector 47.

With the case where the plurality of lamp sources 42 are blue-light LEDs as an example, blue lights (regarded as the first original-color lights) may be transmitted to the fluorescent film 43, the fluorescent medium in the fluorescent film 43 may be excited and emits red lights (regarded as the second original-color lights) and green lights (regarded as the third original-color lights), part of the lights may be reflected under the reflection effect of the brightness enhancement film 46 and then may be transmitted towards the substrate 41; and when transmitted to the reflector 47, the lights may be transmitted by the reflector 47 along the light output direction of the backlight module 40, and thus, the light effect may be improved. In the reflecting process, blue lights may be reflected by the reflector 47 and may be transmitted to the fluorescent film 43 again, the fluorescent medium may continue to be excited to emit red lights and green lights, and thus, the light effect may be further improved.

It should be understood that the backlight module 40 in the embodiments of the disclosure may further include other structural elements such as a rubber frame, and the configuration and operating principle of all these structural elements can be realized with the related art as reference.

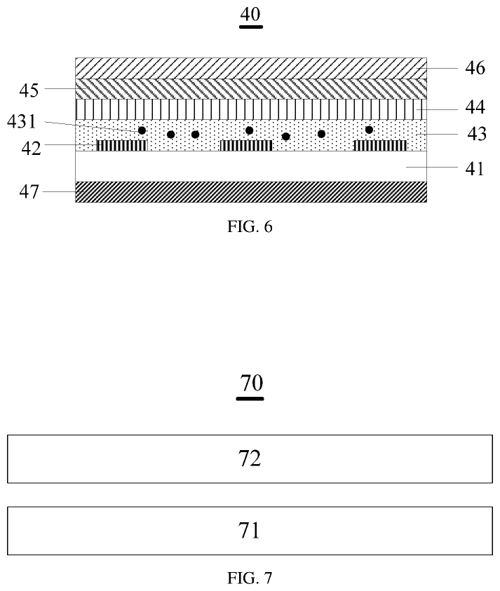

FIG. 6 is a cross-sectional schematic view of the backlight module in another embodiment of the disclosure. For the sake of a brief description, identical reference signs are used to represent structural elements with identical names in this embodiment. Based on the description of the prior embodiments, this embodiment differs from the prior embodiments in that the reflector 47 may be disposed on a side, backing onto the plurality of lamp sources 42, of the substrate 41, that is to say, the reflector 47 may be attached to a back side of the substrate 41, as shown in FIG. 6. In addition, the substrate 41 may be a transparent substrate in this embodiment.

Still with the case where the plurality of lamp sources 42 are blue-light LEDs as an example, when blue lights are transmitted to the fluorescent film 43, the fluorescent medium in the fluorescent film 43 may be excited and emits red lights and green lights, part of the lights may be reflected under the reflection effect of the brightness enhancement film 46, penetrate through the transparent substrate 41 and then may be transmitted to the reflector 47, the reflector 47 may transmit the lights along the light output direction of the backlight module 40, and thus, the light effect may be improved. Similarly, in the reflecting process, blue lights reflected by the reflector 47 and then may be transmitted to the fluorescent film 43 again, the fluorescent medium may continue to be excited to emit red lights and green rights, and thus, the light effect may be further improved.

Based on the above description, the substrate 41 may be made from transparent polyimide (PI) and may resist a temperature higher than the temperature required for crystal solidification and reflow soldering of the LEDs (lamp sources 42) as well as higher than the temperature required for melting the fluorescent film 43, and thus, the stability of the substrate 41 may still be kept when the LEDs are assembled and the fluorescent film 43 is formed.

Furthermore, in order to prevent lights from getting lost in the repeated reflecting process, the surface of a drive wire on the substrate 41 may also have a light reflecting function, and particularly, the drive wire may be made from a high-reflectivity metal such as silver or aluminum.

The disclosure may further provide a display device 70. As shown in FIG. 7, the display device 70 may include a backlight module 71 and a liquid crystal display panel 72 disposed along a light output direction of the backlight module 71. The backlight module 71 may be the backlight module 40 described in any of the above embodiments. In this way, the display device 70 may also has the beneficial effects achieved by the backlight module 40.

Again, the above description is only intended to explain embodiments of this application rather than to limit the patent scope of this application. All equivalent structures or equivalent process transformations based on the contents in the specification and drawings of this application, such as technical characteristic combinations of the embodiments, or direct or indirect applications to other relevant technical fields, should also fall within the patent protection scope of this application.

What is claimed is:

1. A backlight module, comprising:
a substrate, and a plurality of lamp sources, a fluorescent film, a pointing film and a brightness enhancement film disposed on the substrate;
the fluorescent film disposed along a light output direction of the plurality of lamp sources and comprising a transparent adhesive, and a fluorescent medium and scattering particles mixed in the transparent adhesive, and the scattering particles having a reflectivity smaller than a reflectivity of the transparent adhesive;
the pointing film and the brightness enhancement film disposed along a light output direction of the fluorescent film, and the pointing film located between the fluorescent film and the brightness enhancement film;
wherein the pointing film is of an integrally-molded structure and comprises a transparent body and a plurality of tapered protrusions arrayed on a surface of one side of the transparent body at intervals; and a central angle of each of the plurality of tapered protrusions is an acute angle and is 10°-60°.

2. The backlight module according to claim 1, wherein a vertex angle of each of the plurality of tapered protrusions is an acute angle and is at least over 30°.

3. The backlight module according to claim 1, wherein the pointing film is prepared from at least one selected from polymethyl methacrylate (PMMA), polycarbonate (PC), polystyrene (PS) and styrene-methyl methacrylate copolymer (MS) through injection molding.

4. The backlight module according to claim 1, further comprising:
a reflector, disposed on the substrate, defining a plurality of open areas, and the plurality of lamp sources located in the plurality of open areas; or the substrate being a transparent substrate, the backlight module further comprising a reflector, attached to a side, backing onto the plurality of lamp sources, of the substrate.

5. The backlight module according to claim 1, further comprising a diffusion film located between the fluorescent film and the pointing film.

6. A backlight module, comprising:
a substrate, and a plurality of lamp sources, a fluorescent film, a pointing film and a brightness enhancement film disposed on the substrate;
the fluorescent film disposed along a light output direction of the plurality of lamp sources, and the pointing film and the brightness enhancement film disposed along a light output direction of the fluorescent film; the pointing film located between the fluorescent film and the brightness enhancement film and comprising a transparent body and a plurality of tapered protrusions arrayed on a surface of one side of the transparent body at intervals; and a central angle of each of the plurality of tapered protrusions is an acute angle.

7. The backlight module according to claim 6, wherein the central angle of each of the plurality of tapered protrusions is 10°-60°.

8. The backlight module according to claim 6, wherein a vertex angle of each of the plurality of tapered protrusions is an acute angle and is at least over 30°.

9. The backlight module according to claim 6, wherein the pointing film is of an integrally-molded structure.

10. The backlight module according to claim 9, wherein the pointing film is prepared from at least one selected from polymethyl methacrylate (PMMA), polycarbonate (PC), polystyrene (PS) and styrene-methyl methacrylate copolymer (MS) through injection molding.

11. The backlight module according to claim 6, wherein the fluorescent film comprises a transparent adhesive, and a fluorescent medium and scattering particles mixed in the transparent adhesive, and the scattering particles have a reflectivity smaller than a reflectivity of the transparent adhesive.

12. The backlight module according to claim 6, wherein the backlight module further comprises a reflector disposed on the substrate, the reflector defines a plurality of open areas, and the plurality of lamp sources are located in the plurality of open areas.

13. The backlight module according to claim 6, wherein the substrate is a transparent substrate, the backlight module further comprises a reflector attached to a side, backing onto the lamp sources, of the substrate.

14. The backlight module according to claim 6, further comprising a diffusion film located between the fluorescent film and the pointing film.

15. A display device, comprising:
a backlight module, and the backlight module comprising a substrate, and a plurality of lamp sources, a fluorescent film, a pointing film and a brightness enhancement film disposed on the substrate;
the fluorescent film disposed along a light output direction of the plurality of lamp sources, and the pointing film and the brightness enhancement film disposed along a light output direction of the fluorescent film; the pointing film located between the fluorescent film and the brightness enhancement film and comprising a transparent body and a plurality of tapered protrusions arrayed on a surface of one side of the transparent body; and a central angle of each of the plurality of tapered protrusions is an acute angle.

16. The display device according to claim 15, wherein the central angle of each of the plurality of tapered protrusions is 10°-60°, and a vertex angle of each of the plurality of tapered protrusions is an acute angle and is at least over 30°.

17. The display device according to claim 15, wherein the pointing film is of an integrally-molded structure and is prepared from at least one selected from polymethyl methacrylate (PMMA), polycarbonate (PC), polystyrene (PS) and styrene-methyl methacrylate copolymer (MS) through injection molding.

18. The display device according to claim 15, wherein the fluorescent film comprises a transparent adhesive, and a fluorescent medium and scattering particles mixed in the transparent adhesive, and the scattering particles have a reflectivity smaller than a reflectivity of the transparent adhesive.

19. The display device according to claim 15, wherein the backlight module further comprises a reflector disposed on the substrate, the reflector defines a plurality of open areas, and the plurality of lamp sources are located in the plurality of open areas; or the substrate is a transparent substrate, the backlight module further comprises a reflector, and the reflector is attached to a side, backing onto the lamp sources, of the substrate.

20. The display device according to claim 15, wherein the backlight module further comprises a diffusion film located between the fluorescent film and the pointing film.
